(19) United States
(12) Patent Application Publication
(10) Pub. No.: US 2013/0140058 A1
(43) Pub. Date: Jun. 6, 2013

(54) GRAPHENE ELECTRICAL WIRE AND A METHOD FOR MANUFACTURING THEREOF

(71) Applicants: Ki II KIM, Los Angeles, CA (US); Young K. KIM, Los Angeles, CA (US); Sang-Woo KIM, Gyeonggi-do (KR)

(72) Inventors: Ki II KIM, Los Angeles, CA (US); Young K. KIM, Los Angeles, CA (US); Sang-Woo KIM, Gyeonggi-do (KR)

(21) Appl. No.: 13/311,376

(22) Filed: Dec. 5, 2011

(51) Int. Cl. H01B 5/00; B05D 5/12

(52) U.S. Cl. 174/126.2; 427/117

(57) ABSTRACT

The present disclosure relates to a graphene electrical wire and a method for manufacturing thereof. In particular, the graphene electrical wire includes a metal core having a shape of fiber, and a graphene layer synthesized on the outer surface of the metal core. Also, the method includes the steps of providing a metal core having a shape of fiber, and synthesizing a graphene layer on the outer surface of the metal core.

### BACKGROUND OF THE INVENTION

1. Field of the Invention

This invention relates to a method for coating graphene on the surface of wire using metal wire as a catalyst by the Large Scale Graphene Synthesis using the metal catalyst such as copper, nickel, and ruthenium.

2. Description of Related Art

A conventional wire is made of copper which has high electrical conductivity. Copper allows current to flow easily and emit low heat due to low resistivity. Also, copper has advantage of easy manufacturing due to high ductility and tensile strength. As the price of raw material has a tendency of rising, copper prices also have risen from 6,299 U.S. dollars per ton in 2009 to 10,070 U.S. dollars per ton in 2011, and this tendency is expected to continue in the future. Also, copper wire has the disadvantage of that the diameter is increased in a proportion to the amount of electrical power.

As the price of copper rises, interest for a new conductible material which can replace the copper is growing. In terms of the electricity conductivity, aluminum cannot replace the copper because of the low electrical conductivity, and gold and silver, having a higher electrical conductivity, cannot replace copper because of high prices.

### SUMMARY OF THE INVENTION

This invention includes a method of coating a metal catalyst layer on a fiber shape polymer, which is a core of wire, using a coating method such as electrolysis and evaporation.

In accordance with an aspect of the present invention, a graphene electrical wire includes a metal core having a shape of fiber, and a graphene layer synthesized on the outer surface of the metal core.

In accordance with another aspect of the present invention, a method for manufacturing an electrical wire is provided. The method includes the steps of providing a metal core having a shape of fiber, and synthesizing the graphene layer on the outer surface of the metal core.

In accordance with another aspect of the present invention, a graphene electrical wire includes a polymer core, a metal layer coated on the polymer core, and a graphene layer synthesized on the outer surface of the metal layer.

Also, in accordance with another aspect of the present invention, provided is a method for manufacturing an electrical wire, the method including the steps of providing a polymer core, coating a metal layer on the polymer core, and synthesizing the graphene layer on the outer surface of the metal layer.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 illustrates a graphene electrical wire including a fiber shape metal core made of one of, copper (Cu), nickel (Ni), and ruthenium (Ru), and a graphene layer synthesized on the outer surface of the metal core according to one embodiment of the present invention; and

FIG. 2 illustrates a graphene electrical wire comprising a polymer core, a metal layer coated on the polymer core, and a graphene layer synthesized on the outer surface of the metal layer according to another embodiment of the present invention.

### DETAILED DESCRIPTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments. In the drawings, like reference numerals in the drawings denote like elements. The shape, size and regions, and the like, of the drawing may be exaggerated for clarity.

According to one aspect of the present invention, a graphene electrical wire includes a metal core having a shape of fiber, and a graphene layer synthesized on the outer surface of the metal core.

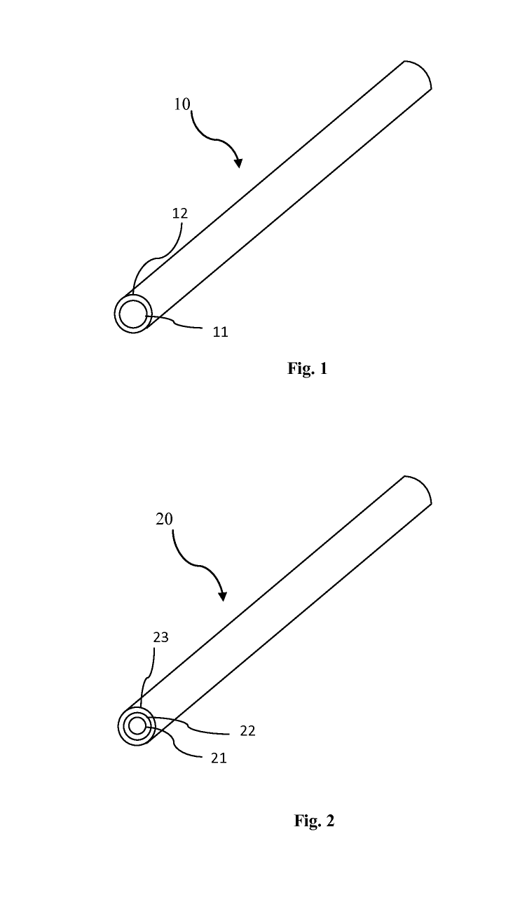

FIG. 1 illustrates a graphene electrical wire 10 according to one aspect of the present invention. The graphene electrical wire 10 can include a metal core 11 having a shape of fiber, and a graphene layer 12 synthesized on the outer surface of the metal core 11. The metal core 11 can be made of one of, copper (Cu), nickel (Ni), and ruthenium (Ru).

The graphene layer 12 can be synthesized by Chemical Vapor Deposition or Large Scale Graphene Synthesis. The Large Scale Graphene Synthesis became possible using copper as a catalyst since professor Ruoff at the UC Texas at Austin published a relevant thesis (see Xuesong Li et al., “Large-Area Synthesis of High-Quality and Uniform Graphene Films on Copper Foils,” Science, 5 Jun. 2009: 1312-1314). Also, professor Tumor at Rice University succeeded the Large Scale Graphene Synthesis using a polymer solid source with a copper catalyst (see Sun et. al., “Growth of Graphene from Solid Carbon Sources. Nature Letters.” Vol. 468, 2010: 549-552)

In another exemplary embodiment of the present invention, the graphene layer 12 can be produced by exfoliation.

According to another aspect of the present invention, a graphene electrical wire can include a polymer core, a metal layer coated on the outer surface of the polymer core, and a graphene layer synthesized on the outer surface of the metal layer.

FIG. 2 illustrates a graphene electrical wire 20 according to one aspect of the present invention. Referring to FIG. 2, a graphene electrical wire 20 can include a polymer core 21, a metal layer 22 coated on the outer surface of the polymer core 21, and a graphene layer 23 synthesized on the outer surface of the metal layer 22. The metal layer 22 can be made of one of, copper (Cu), nickel (Ni), and ruthenium (Ru). The graphene layer 23 can be synthesized by chemical vapor deposition, or can be produced by exfoliation.

By using the graphene having 100 times the current density of copper, high heat conductivity, and chemical resistance, it is possible to manufacture an electrical wire which is thin, but having high electrical conductivity. As the thickness of wire is reduced, the amount of copper decreases, and thus, the economic loss can be reduced due to increasing global copper prices.

Also, graphene electrical wire can be used to protect the environment by reducing the amount of copper, which is a mineral, as it uses the polymer or graphene, both of which are organic materials. Also, graphene wire can be used to reduce the manufacturing cost of existing electrical wire and allow efficient electrical supply due to its high current density.

What is claimed is:

1. An electrical wire comprising:
a metal core having a shape of fiber; and
a graphene layer synthesized on an outer surface of the metal core.

2. The electrical wire of claim 1, wherein the metal core is made of one of, copper (Cu), nickel (Ni), and ruthenium (Ru).

3. The electrical wire of claim 1, wherein the graphene layer is synthesized by chemical vapor deposition.

4. The electrical wire of claim 1, wherein the graphene layer is produced by exfoliation

5. A method for manufacturing an electrical wire, the method comprising:
providing a metal core having a shape of fiber; and
synthesizing a graphene layer on an outer surface of the metal core.

6. The method of claim 5, wherein the metal core is made of one of, copper (Cu), nickel (Ni), and ruthenium (Ru).

7. The method of claim 5, wherein the graphene layer is synthesized by chemical vapor deposition.

8. The method of claim 5, wherein the graphene layer is produced by exfoliation.

9. An electrical wire comprising:
a polymer core;
a metal layer coated on an outer surface of the polymer core; and
a graphene layer synthesized on an outer surface of the metal layer.

10. The electrical wire of claim 9, wherein the metal layer is made of one of, copper (Cu), nickel (Ni), and ruthenium (Ru).

11. The electrical wire of claim 9, wherein the graphene layer is synthesized by chemical vapor deposition.

12. The electrical wire of claim 9, wherein the graphene layer is produced by exfoliation.

13. A method for manufacturing an electrical wire, the method comprising:
providing a polymer core;
coating a metal layer on an outer surface of the polymer core; and
synthesizing a graphene layer on an outer surface of the metal layer.

14. The method of claim 13, wherein the metal core is made of one of, copper (Cu), nickel (Ni), and ruthenium (Ru).

15. The method of claim 13, wherein the graphene layer is synthesized by chemical vapor deposition.

16. The method of claim 13, wherein the graphene layer is produced by exfoliation.
